(19) United States
(12) Patent Application Publication
(10) Pub. No.: US 2026/0254860 A1
(43) Pub. Date: Aug. 27, 2026

(54) SYSTEMS AND METHODS FOR SESSION-BASED DEVICE ASSOCIATIONS

(71) Applicant: Netflix, Inc., Los Gatos, CA (US)

(72) Inventors: Olivier Poitrey, Le Chesnay (FR); Sean Freiburg, Issaquah, WA (US); James Edward Smith, Washington, DC (US); Bernice Beryl Oosterling, Bellevue, WA (US); Jared Haren, Ladera Ranch, CA (US); Nicholas Wayne Higgins, Portland, OR (US); Luke Geiger, Royal Oak, MI (US)

(21) Appl. No.: 19/356,856

(22) Filed: Oct. 13, 2025

Related U.S. Application Data
(60) Provisional application No. 63/763,180, filed on Feb. 25, 2025.

(51) Int. Cl. H04L 65/1069; H04L 67/55

(52) U.S. Cl. CPC H04L 65/1069; H04L 67/55

(57) ABSTRACT

A computer-implemented method may include creating a temporary association between a display device and a mobile computing device of a user that is not authenticated to the display device, where the temporary association is valid for a predefined period of time. Based on the temporary association, the user is enabled to use the mobile computing device to interact with a first media session on the display device. The method further includes determining that the temporary association is valid for a second media session on the display device, and enabling the mobile computing device to interact with the second media session based at least in part on determining that the temporary association is still valid. Various other methods, systems, and computer-readable media are also disclosed.

### CROSS REFERENCE TO RELATED APPLICATION

This application claims priority to U.S. Provisional Application No. 63/763,180, filed 25 Feb. 2025, the disclosure of which is incorporated, in its entirety, by this reference.

### BACKGROUND

In recent years, the proliferation of cloud-based gaming and interactive media services has driven widespread adoption of multi-device ecosystems in the home and beyond. Users increasingly rely on their smartphones or tablets as companion controllers to initiate and manage media sessions displayed on remote screens, including smart TVs, streaming devices, and web browsers. These second-screen experiences span casual single-player gameplay, cooperative group activities, and live interactive events, each involving uninterrupted, responsive communication between a display client and one or more mobile devices. Traditional cloud gaming platforms and streaming services may not adequately address evolving demands of these systems or the needs of users expecting a seamless, efficient experience.

### SUMMARY

As will be described in greater detail below, the present disclosure describes systems and methods for session-based device associations. In some aspects, the techniques described herein relate to a computer-implemented method including: creating a temporary association between a display device and a mobile computing device of a user that is not authenticated to the display device, the temporary association being valid for a predefined period of time; enabling, based on the temporary association, the user to use the mobile computing device to interact with a first media session on the display device; determining that the temporary association is valid for a second media session on the display device; and enabling the mobile computing device to interact with the second media session based at least in part on determining that the temporary association is still valid.

In some aspects, the techniques described herein relate to a system including: at least one physical processor; physical memory including computer-executable instructions that, when executed by the physical processor, cause the physical processor to: create a temporary association between a display device and a mobile computing device of a user that is not authenticated to the display device, the temporary association being valid for a predefined period of time; enable, based on the temporary association, the user to use the mobile computing device to interact with a first media session on the display device; determine that temporary association is valid for a second media session on the display device; and enable the mobile computing device to interact with the second media session based at least in part on determining that the temporary association is still valid.

In some aspects, the techniques described herein relate to a non-transitory computer-readable medium including one or more computer-executable instructions that, when executed by at least one processor of a computing device, cause the computing device to: create a temporary association between a display device and a mobile computing device of a user that is not authenticated to the display device, the temporary association being valid for a predefined period of time; enable, based on the temporary association, the user to use the mobile computing device to interact with a first media session on the display device; determine that temporary association is valid for a second media session on the display device; and enable the mobile computing device to interact with the second media session based at least in part on determining that the temporary association is still valid.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for establishing a temporary association between a display device and a mobile computing device.

FIG. 2 is a depiction of an interface receiving a notification for managing session-based device associations across multiple media sessions.

FIG. 3 is a depiction of an interface for interacting with push notifications that prompt reconnection of a mobile device to a display device.

FIG. 4 shows an example of a display device connected to multiple mobile computing devices in a media session.

FIG. 5 is a block diagram of an exemplary content distribution ecosystem.

FIG. 6 is a block diagram of exemplary components of content distribution infrastructure according to certain embodiments.

FIG. 7 is a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As noted, the proliferation of cloud-based gaming and interactive media services has led to an increased reliance on multi-device ecosystems, where users often employ mobile devices, such as smartphones or tablets, as controllers for media sessions displayed on larger screens, such as smart TVs, streaming devices, or web browsers. However, existing methods for establishing connections between these devices, such as QR code scanning, introduce significant friction into the user experience. While QR codes are widely understood and effective for initial device pairing, they require repetitive manual actions for subsequent connections, particularly in scenarios involving frequent reconnections or multiplayer gaming sessions. This repetitive process can lead to user frustration, reduced engagement, and higher drop-off rates. Furthermore, QR code-based approaches fail to leverage contextual or historical data, such as prior connections, shared account information, or network proximity, to streamline the connection process. These limitations result in inefficiencies and missed opportunities to create a seamless, intuitive, and user-friendly experience.

Aspects of the present disclosure address one or more of these shortcomings by introducing systems and methods for session-based device associations that reduce reliance on QR code scanning and enhance the overall user experience. The described approach leverages a combination of temporary associations, push notifications, and contextual data to enable seamless reconnections between mobile devices and display devices. In some examples, the described system may use a "next game token" mechanism that creates a temporary association between a mobile device and a display device for a predefined period. This association enables users to reconnect to subsequent media sessions without the need for repeated QR code scans.

In some aspects, the system intelligently utilizes contextual signals, such as prior connection history, network proximity, and device-specific tokens, to dynamically prompt eligible devices for reconnection. Additionally, the described approach incorporates safeguards to minimize false positives and provide secure, private sessions, such as verifying network conditions or user intent before displaying notifications.

By integrating these mechanisms, the described system significantly reduces user friction, enabling one-tap reconnections and enhancing the overall efficiency of the connection process. The system architecture supports both single-player and multiplayer scenarios, dynamically managing device associations and notifications to accommodate multiple users. Furthermore, the described system is designed to be privacy-conscious, ensuring that temporary associations are securely managed and automatically invalidated after the predefined period. This approach not only improves the technical efficiency of device pairing but also enhances user engagement by providing a more intuitive and adaptable connection flow.

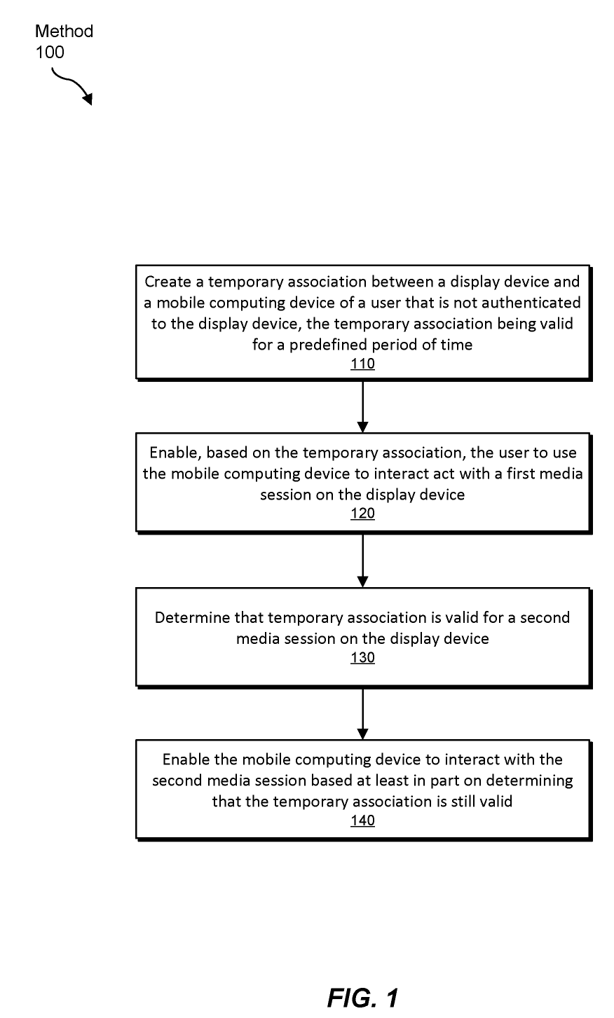

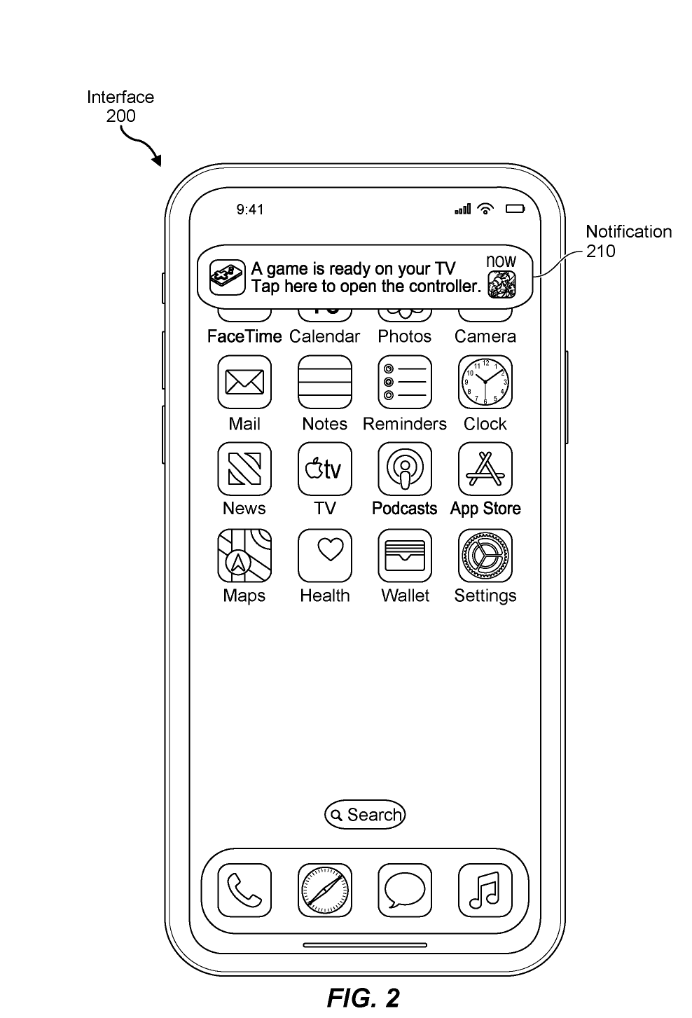

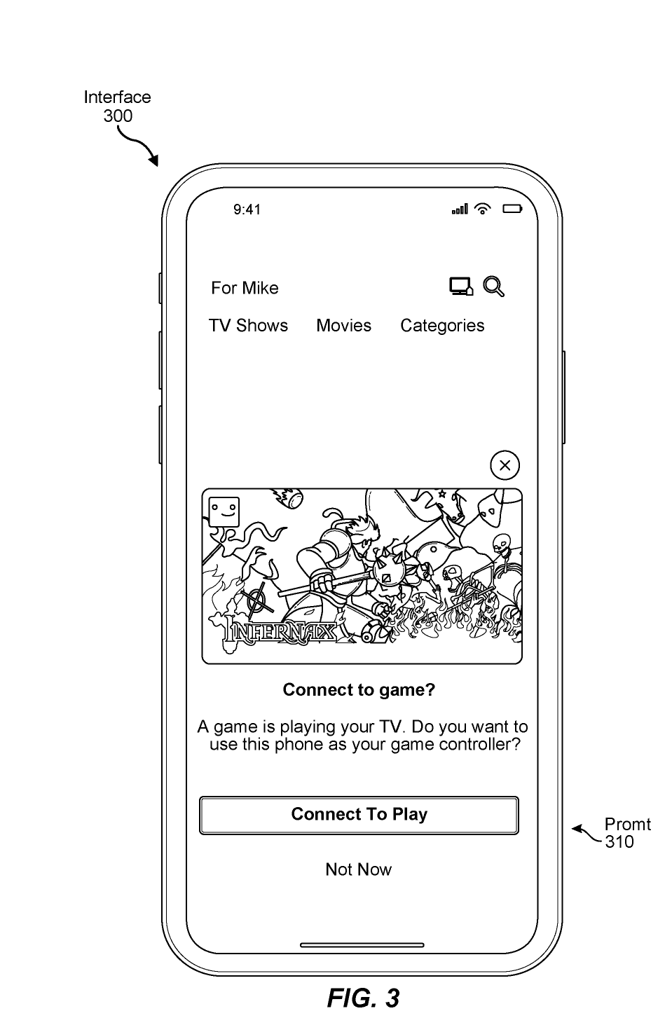

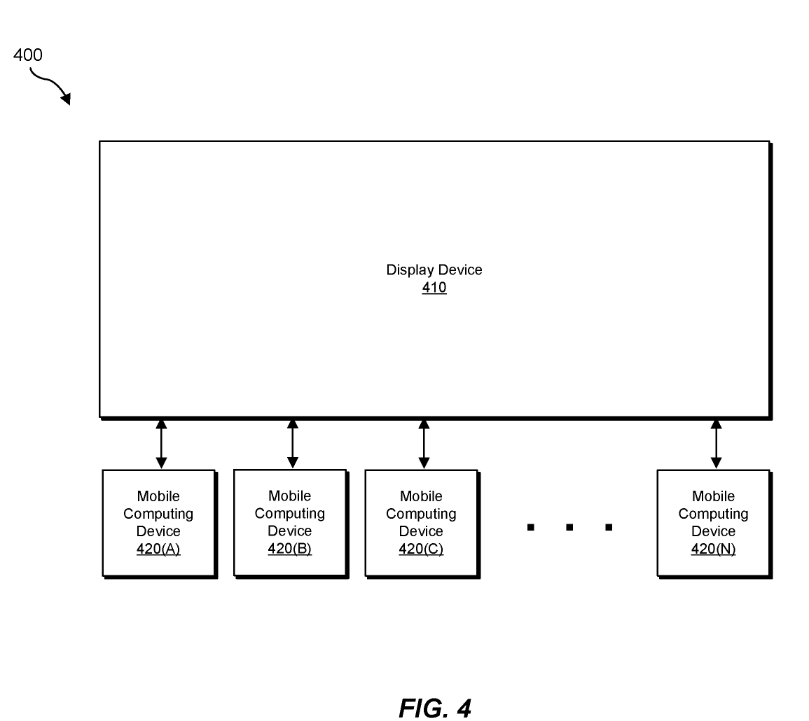

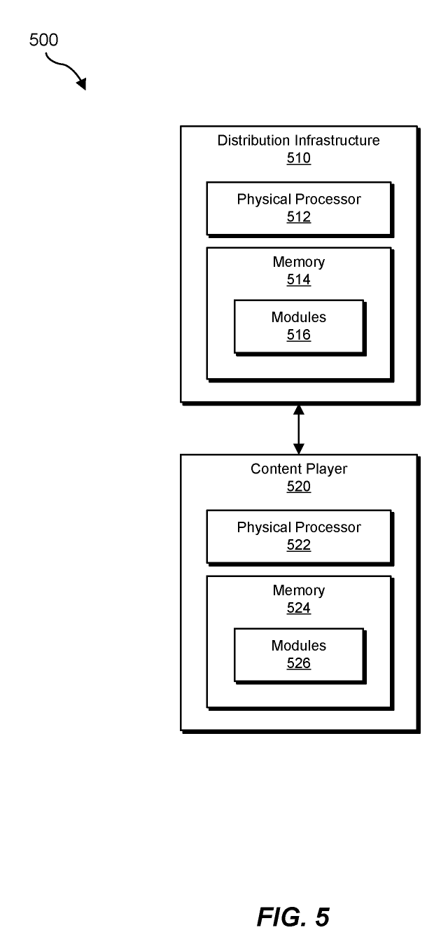

The accompanying drawings illustrate various exemplary embodiments of the present disclosure and are referenced throughout the detailed description to demonstrate and explain key aspects of the systems and methods for session-based device associations. The description corresponding to FIG. 1 provides an overview of a method for enabling sessions-based device associations, and the descriptions corresponding to FIGS. 2 and 3 introduces examples of interfaces for managing these sessions. The description corresponding to FIG. 4 explains multi-user sessions, and the description of FIGS. 5-7 covers devices and networks in which aspects of this disclosure are implemented.

FIG. 1 is a flow diagram of an exemplary computer-implemented method 100 for creating and managing temporary associations between devices. The steps shown in FIG. 1 may be performed by any suitable computer-executable code and/or computing system, including the system(s) illustrated in FIGS. 5-7. In one example, each of the steps shown in FIG. 1 may represent an algorithm whose structure includes and/or is represented by multiple sub-steps, examples of which will be provided in greater detail below.

As illustrated in FIG. 1, at step 110, one or more of the systems described herein may create a temporary association between a display device and a mobile computing device of a user that is not authenticated to the display device. This temporary association is a time-limited linkage, typically lasting for a predefined period such as six hours, and is designed to facilitate seamless interactions between devices in a session-based environment while balancing convenience and security. The association enables unauthenticated device connections, allowing users—such as guests or casual participants—to join media sessions without the need for account credentials on both devices. In many embodiments, the mobile device generates or provides a device-specific token, such as an Apple Push Notification Service (APNS) token or a Firebase Cloud Messaging (FCM) token, which uniquely identifies the device and enables the backend system to send targeted notifications or prompts. The backend receives this token and associates it with the display device’s identifier, such as an Electronic Serial Number (ESN) or globally unique identifier (GUID), storing the mapping temporarily to facilitate future interactions like reconnection prompts.

For example, a user may scan a QR code displayed on a TV using their mobile device, prompting the mobile app to send its device token to the backend and establish the temporary association, which remains valid for a set period and allows the user to reconnect without repeating the QR code scan. Alternatively, on iOS, the user may launch an App Clip by scanning a QR code or tapping a deep link (e.g., a hyperlink that sends a user directly to a specific section and/or media session of a mobile app), automatically registering the device token with the backend. Manual code entry is another alternative, where the user enters a short code from the TV into the mobile app to initiate the association. Network-based discovery is also possible; if both devices are on the same local network, the display device can broadcast a beacon using protocols such as SSDP/DIAL, which the mobile app detects and uses to send its device token to the backend, establishing the association without a QR code scan. Location-based discovery is another option, where a mobile device within a particular geographic area, building, room, etc. may be prompted to establish a temporary association.

In some examples, the duration of the association is configurable, ranging from several hours to multiple days, depending on user preferences or application context. The system can also support multiple temporary associations for a single display device, enabling several mobile devices to connect as controllers in multiplayer scenarios, with each association managed independently. Additionally or alternatively, the system can support multiple temporary associations for a single mobile device (e.g., a mobile device can be connected to multiple display devices). In cases where the mobile device is authenticated with the same account as the display device, the system may create a persistent association rather than a temporary one, allowing for seamless reconnections across sessions and devices. Additional contextual signals, such as prior connection history, device location, or network fingerprint, are used in some aspects to determine whether to create or extend a temporary association. Security and privacy measures, such as user confirmation, network proximity verification, or limits on simultaneous associations, can be implemented to prevent unauthorized connections.

Step 110 can be implemented in a variety of use cases, such as party games where multiple guests scan a QR code on the host’s TV to join and reconnect to game sessions, hotel room TVs where multiple guests connect their devices for streaming or gaming during their stay, or conference feedback systems where attendees connect to a presentation system for live interaction.

As indicated, the term “temporary association” generally refers to a time-limited, non-persistent linkage established between a display device—such as a smart TV, streaming device, or web browser—and a mobile computing device, like a smartphone or tablet, for the purpose of enabling interactive communication or control during one or more media sessions. Unlike persistent associations, which rely on user authentication or long-term device pairing, a temporary association is valid only for a predefined period, such as several hours or days, a week, two weeks, three weeks, etc. and is automatically invalidated upon expiration or completion of the relevant session. This mechanism enables users, including guests or unauthenticated participants, to interact with a display device without requiring account credentials or permanent device registration, thereby reducing friction and enhancing convenience in scenarios where rapid, flexible connections are desired.

For example, during a party game, multiple guests can scan a QR code displayed on the host’s TV to join a multiplayer game, with each guest’s mobile device temporarily associated with the TV for the duration of the game (i.e., media session), allowing seamless reconnections without repeated QR scans. In a hotel room, a guest scans a QR code on the in-room TV to connect their mobile device for streaming or gaming, with the association lasting for the duration of their stay or a set time window to protect privacy.

At a conference, attendees can connect their devices to a presentation system for live feedback or voting, with the temporary association expiring once the session ends. In a classroom, students may use tablets to join an interactive quiz or poll by scanning a code on the display, with the association valid for the class period. Family members can connect their phones to a smart TV for a group trivia game before watching a movie, with the association automatically removed after the session. Virtual fitness class participants may scan a code to sync their devices for real-time feedback, with the association expiring after the class. Shoppers in a retail store can participate in a promotional game or survey by scanning a display code, with the association valid only during the promotion. Roommates may connect their phones to a shared TV for collaborative playlist management or gaming, with each device temporarily associated for the evening. These examples illustrate the flexibility of temporary associations across diverse environments and use cases, supporting both authenticated and unauthenticated users and enabling secure, convenient, and context-sensitive device interactions.

In some embodiments, the term “temporary association” does not necessarily mean an association with a short, fixed duration. For example, a trust point system may be implemented where a repeated association of two devices increases trust and extends the duration of an association. In this embodiment, if an association is made between two devices, that association can be strengthened in response to a trigger. That trigger can be any of the examples of the ways in which a temporary association is first established (e.g., scanning a QR code) or in which a temporary association can be reestablished (e.g., via a link in a push notification). Any other suitable trigger can also strengthen an association.

When a temporary association is described as “valid for a predefined period of time,” it means that the linkage between the display device and the mobile computing device is established with a specific, predetermined duration during which the association remains active and functional. During this period, the mobile device can interact with the display device—such as joining, controlling, or reconnecting to media sessions—without needing to repeat the initial connection process (for example, scanning a QR code or entering a code). Once the predefined time interval expires, the association is automatically invalidated, and the mobile device must re-establish the connection to continue interacting with the display device.

For instance, if the predefined period is set to six hours, the temporary association will allow the user’s mobile device to reconnect and participate in sessions on the display device for up to six hours from the time of initial pairing. After six hours, the system will remove or deactivate the association, requiring the user to perform the connection process again if they wish to continue interacting. This approach ensures both convenience and security, as it enables seamless, short-term interactions while preventing indefinite or unauthorized access beyond the intended time window. The predefined period may be configurable based on application context, user preferences, or security requirements, and can range from minutes to days or weeks depending on the use case.

In some examples, each time the user reconnects to the display device, the predefined period is extended. Extending the time period can be accomplished by enabling each connection request/event to have access to the implicit device identity being used for the connection (e.g., the device token). By extending the time period associated with a particular device token each time the user reconnects, the lifetime of the temporary association can be directly related to the user’s engagement with the display device.

The phrase “mobile computing device of a user that is not authenticated to the display device” refers to a portable electronic device—such as a smartphone, tablet, or similar device—operated by a user, where the device has not established a persistent, credential-based relationship with the target display device, such as a smart TV, streaming device, or web browser. In these scenarios, the mobile computing device interacts with the display device without requiring the user to enter account credentials, perform device registration, or otherwise authenticate through conventional means. This enables guest access, casual participation, and rapid, frictionless connections for users who may not have an account or do not wish to perform a full authentication process.

For example, a guest’s smartphone may be used to join a party game on a friend’s smart TV without logging into any account on the TV, or a hotel guest may connect their tablet to the in-room TV for gaming or streaming without entering credentials. Similarly, an attendee’s mobile phone can participate in live voting or feedback during a conference presentation without being registered or logged into the conference display system, and a student’s tablet may join a classroom quiz session displayed on a teacher’s web browser without any prior authentication. Other examples include a shopper’s smartphone interacting with a promotional game on a retail store’s display screen, a family member’s phone joining a trivia game on a shared living room TV, a roommate’s tablet managing a collaborative playlist on a smart TV, a participant’s mobile device connecting to a virtual fitness class displayed on a streaming device, or a visitor’s smartphone joining a multiplayer game session on a host’s TV—all without any account login or persistent device pairing. Another example is a physical entertainment venue, such a movie theater, theme park, or other venues designed to enable fans of shows and movies to interact with experiences based on the shows and movies.

Returning to FIG. 1, at step 120, the system enables, based on the temporary association, the user to use the mobile computing device to interact with a first media session on the display device. This step leverages the previously established temporary association to facilitate seamless, real-time communication and control between the mobile device and the display device, without requiring additional authentication or manual connection steps. The interaction can encompass a wide range of activities, such as joining a game session, controlling playback of streaming content, participating in live polls or feedback, engaging with interactive content, or managing collaborative playlists. For example, after a guest scans a QR code and establishes a temporary association with a smart TV, the guest can immediately use their smartphone as a game controller to join a multiplayer game, or as a remote to control video playback. In a classroom setting, a student’s tablet may be used to submit answers to a quiz displayed on the teacher’s web browser, while in a hotel room, a guest’s tablet can stream personal content to the in-room TV for the duration of their stay.

The system may support various interaction modalities, including touch controls, voice commands, gesture recognition, or even haptic feedback, depending on the capabilities of the mobile device and the display device. Alternatives to direct interaction include sending push notifications to the mobile device with deep links that, when activated, automatically connect the device to the relevant media session and/or showing one-tap connection prompts within applications (e.g., in situations where the application is already open). In some embodiments, the interaction may be context-sensitive, such as enabling different control options for single-player versus multiplayer games or providing tailored interfaces for different types of media sessions (e.g., video streaming, gaming, live events).

The system, in some examples, enables multiple mobile devices to interact with the same display device simultaneously, supporting group activities or collaborative experiences. Additionally, safeguards may be implemented to ensure that only devices with a valid temporary association can interact with the session, thereby maintaining security and preventing unauthorized access.

The term “media session” refers to a discrete instance of interactive or consumable digital content that is presented, played, or managed on a display device, and with which a user or group of users may engage through various forms of input or control. A media session may encompass activities such as streaming video or audio, playing a game, participating in a live event, engaging in collaborative playlists, or interacting with real-time feedback systems. Media sessions are typically bounded in time and context and can involve one or more users interacting with the content via mobile computing devices, remote controls, or other input mechanisms.

For example, a media session can be streaming a movie or TV show on a smart TV, where users control playback and volume from their mobile devices, or playing a cloud-based multiplayer game on a streaming device, with multiple users joining as game controllers via their smartphones. Other examples include participating in a live trivia event displayed on a web browser, managing a collaborative music playlist on a smart TV, engaging in a virtual fitness class streamed to a display device, attending a remote classroom session with interactive quizzes, joining a conference presentation with live audience feedback, participating in a promotional game or survey in a retail store, or controlling photo slideshows and presentations on a streaming device.

In some examples, a media session runs on an independent server. In these examples, the display streams the media session to the user, and the mobile computing devices are actually connecting to the independent server to control/influence the media and not connecting directly to the display. Thus, an association can be made between a mobile computing device and a display via an intermediary (i.e., a media session server) and without direct connection between the display and the remote computing device.

As illustrated in FIG. 1, at step 130, the system determines that the temporary association between the display device and the mobile computing device is valid for a second media session on the display device. This step involves verifying that the previously established temporary association has not expired and that the conditions for continued interaction are satisfied. The system can check the predefined validity period, ensuring that the association remains active—such as confirming that the six-hour window has not elapsed since the initial pairing. Additionally, the system can evaluate contextual signals, such as whether the mobile device is on the same network as during the initial association, whether the device token matches the stored mapping, or whether the user’s intent to reconnect can be inferred from recent activity or proximity.

For example, after a user has participated in a first game session on a smart TV using their mobile device, the system may launch a second game session and automatically check if the temporary association is still valid. If the association remains active, the user can reconnect without scanning a QR code or entering credentials. In a classroom scenario, a student’s tablet may be used to join a second quiz session on the teacher’s web browser, with the system confirming that the temporary association established earlier is still within its validity period. In a hotel room, a guest may start a new streaming session on the in-room TV, and the system verifies that the guest’s tablet remains temporarily associated for the duration of their stay.

Alternatives and variations for this step include additional safeguards, such as requiring the mobile device to confirm its presence on the same local network, checking for recent device activity, or prompting the user for confirmation before enabling interaction with the second media session. The system can also support extending the validity period if certain conditions are met, such as ongoing user engagement or explicit user requests. In multiplayer scenarios, the system may independently verify the validity of temporary associations for each participating mobile device, ensuring that only eligible users can join subsequent sessions.

When a temporary association is described as “valid,” it means that the linkage between a display device and a mobile computing device remains active, recognized, and functional within the system, allowing the mobile device to interact with the display device without requiring repeating the initial connection process. A valid temporary association has not expired according to its predefined time limit and continues to meet any required contextual or security conditions, such as network proximity, device token matching, or user intent. As long as the association is valid, the user can seamlessly reconnect to media sessions, control content, or participate in interactive activities on the display device.

For example, a guest who scanned a QR code on a friend’s TV to join a party game can reconnect to subsequent games on the same TV within the six-hour validity window, without needing to rescan the QR code. Similarly, a hotel guest who connected their tablet to the in-room TV for streaming can start a new movie or game session during their stay, as long as the temporary association remains within the configured time period. A student who joined a classroom quiz session using their tablet can participate in additional quizzes or polls on the teacher’s web browser during the same class period, provided the association is still valid. Other examples include a family member using their phone to control a smart TV for a trivia game and later managing a collaborative playlist, a participant in a virtual fitness class joining follow-up sessions, a shopper reconnecting to a retail store display for additional rounds of a promotional game, or roommates continuing to interact with a shared TV for collaborative playlist management throughout the evening. These scenarios demonstrate that a valid temporary association enables ongoing, frictionless interaction between mobile computing devices and display devices, supporting a wide range of use cases and user experiences until the association is either manually terminated or automatically invalidated by the system.

As illustrated in FIG. 1, at step 140, the system enables the mobile computing device to interact with a second media session on the display device based at least in part on determining that the temporary association is still valid. This step builds upon the verification performed in the previous step, enabling the user to seamlessly reconnect and participate in new or subsequent media sessions without repeating the initial connection process, such as scanning a QR code or entering credentials. The system can accomplish this by sending a push notification to the mobile device, which can include a deep link or actionable prompt; when the user taps the notification, the mobile device automatically connects to the display device and joins the second media session. In some embodiments, the system may support one-tap reconnection, where a single user action is sufficient to re-establish the interactive link, thereby minimizing friction and enhancing the user experience.

Numerous examples illustrate the flexibility of this approach. For instance, after a guest has played a first party game on a smart TV and the session ends, the host may start a second game; the system recognizes that the guest’s mobile device is still temporarily associated and sends a notification inviting them to join the new session, allowing instant reconnection. In a classroom, a student who participated in a quiz on the teacher’s web browser can immediately join a follow-up poll or educational game, as the system confirms the temporary association is still valid. In a hotel room, a guest who streamed content to the in-room TV can start a new movie or game session during their stay, with the system enabling their tablet to reconnect without additional steps. The system may also support collaborative or multiplayer scenarios, where multiple mobile devices with valid temporary associations are prompted to join a new group activity or game session.

Alternatives and variations for step 140 may include additional safeguards, such as requiring the mobile device to confirm its presence on the same local network, verifying that the identity or configuration of the display device has not changed (e.g., a change could be a profile switch, an account switch, a factory reset of the device, a configuration of the device, an application update, etc.), evaluating recent device activity, or prompting the user for explicit confirmation before enabling interaction with the second media session. The system may also allow for extension of the temporary association’s validity period if ongoing engagement is detected or may trigger dismissal of connection prompts if the association expires. In some cases, the system may support auto-reconnection, where eligible devices are automatically joined to the new session without user intervention, particularly in scenarios where user intent is clear, such as conference feedback or live event participation. Overall, step 140 provides a robust and adaptable mechanism for enabling ongoing, context-sensitive interactions between mobile computing devices and display devices across multiple media sessions, further reducing user friction and supporting a wide range of use cases.

For a mobile computing device to “interact with a media session” means that the device is able to actively participate in, control, or influence the content or experience presented during a media session on a display device. This interaction can take many forms, such as sending commands, providing input, receiving feedback, or engaging in collaborative activities. For example, a smartphone may serve as a game controller to join and play a single player or multiplayer game displayed on a smart TV, or it may be used to control playback functions—such as play, pause, rewind, fast-forward, or volume—of a movie or TV show streamed to a display device.

A tablet may be used to participate in a live poll or trivia event by submitting answers or votes, with results displayed in real time on a web browser, or to manage a collaborative music playlist on a smart TV by adding, removing, or reordering songs. Other forms of interaction include navigating slides or annotating content during a presentation streamed to a display device, providing feedback or ratings during a virtual fitness class, joining a classroom quiz session by submitting answers from a student’s tablet, or interacting with a promotional game or survey in a retail store by scanning a code and using a mobile device to play or respond. Additional examples include using gesture or voice commands from a mobile device to control smart home media playback on a connected TV or speaker system, or receiving push notifications with deep links that, when tapped, automatically connect the mobile device to an active media session for instant participation. These scenarios demonstrate the wide range of ways in which a mobile computing device can interact with a media session, enabling dynamic, engaging, and context-sensitive experiences for users across diverse environments and content types.

To determine that a temporary association is still valid means that the system verifies the continued existence and eligibility of the linkage between a display device and a mobile computing device, ensuring that the association has not expired and that all required contextual or security conditions are satisfied. This process typically involves checking whether the predefined validity period—such as six hours from the initial pairing—has not elapsed, confirming that the device token or identifier matches the stored mapping, and evaluating additional signals such as network proximity, device activity, or user intent.

For example, after a user has connected their smartphone to a smart TV for a party game, the system may check whether the six-hour window is still active before allowing the user to reconnect for a subsequent game session. In a classroom, the system may verify that a student’s tablet remains associated with the teacher’s web browser for the duration of the class period, enabling participation in multiple quizzes. In a hotel room, the system may confirm that a guest’s tablet is still linked to the in-room TV for streaming or gaming throughout their stay. Additional checks may include ensuring that the mobile device is on the same network as during the initial association, confirming recent device activity, or prompting the user for confirmation before enabling further interaction. In both single player and multiplayer scenarios, the system may independently verify the validity of temporary associations for any participating device, ensuring that only eligible users can join new sessions. By determining that a temporary association is still valid, the system maintains secure, seamless, and context-aware interactions between devices, supporting a wide range of use cases and minimizing user friction.

FIG. 2 illustrates an exemplary interface 200 for managing session-based device associations across multiple media sessions. The interface is designed to provide users with clear, actionable options for connecting, reconnecting, and managing their mobile devices in relation to a display device, such as a smart TV or streaming device. In some examples the interface can displays the current status of device associations, including a list of mobile devices that are temporarily linked to the display device, along with relevant details such as device names, connection status, and time remaining before the association expires.

As shown in FIG. 2, interface 200 can also provide a notification 210 that visually indicates when a new media session is available and prompts eligible devices to reconnect. Such notifications can include banners or pop-up prompts that highlight active invitations, display session metadata (such as game titles, session start times, or host information), and provide one-tap actions for users to join or rejoin a session, as shown by the “Connect to Play” notification 310 in interface 300 of FIG. 3.

Example interfaces also support management of multiple device associations, enabling users to view which devices are currently linked, remove devices from the session, or extend the validity period of an association if ongoing engagement is detected. In gaming scenarios, the interface can display avatars or icons representing each participant, along with contextual information such as player roles or activity status. Security and privacy features can be integrated, enabling users to confirm their intent before joining a session, and providing feedback if an association has expired or if additional authentication is required. Additional elements of the interface include visual indicators for network status, device compatibility, and session lifecycle events (such as expiration warnings or session closure notifications).

As noted, FIG. 3 illustrates an exemplary interface 300 for interacting with push notifications that prompt reconnection of a mobile device to a display device. In this example, when a new media session becomes available on the display device, the system sends a push notification 310 to eligible mobile devices.

If the notification 310 is received while the game or streaming application (i.e., the application responsible for the media session) is in the foreground, the interface will display an in-app prompt or modal overlay, providing a richer experience with additional details about the session, a clear call-to-action, and a seamless transition to a media session. The user can review session information and choose to accept or dismiss the prompt. Upon acceptance, the application automatically redeems the beacon code and establishes the connection, bypassing the need for manual steps like scanning a QR code or entering credentials.

In contrast with the example of FIG. 3, when the notification is received in the background, it may appear in the device’s notification center (as shown in FIG. 2). Tapping the notification launches the controller app and immediately presents the reconnection prompt, streamlining the user’s path to participation. The interface may also include visual feedback indicating the success or failure of the connection attempt, such as confirmation messages, error alerts, or status indicators.

In some examples, to enhance usability and minimize confusion, the interface ensures that only relevant and valid notifications are displayed. Expired or invalid session prompts are automatically dismissed, and the user receives clear feedback if an attempt to reconnect is not permitted. In multiplayer scenarios, the interface can differentiate between primary and secondary participants, tailoring notifications and prompts to each user’s role or prior activity.

FIG. 4 shows an exemplary environment 400 in which embodiments of this disclosure may be implemented. As shown in FIG. 4, the display device 410 serves as the interaction point for media sessions. The display device 410 may include, but is not limited to, smart TVs, streaming devices, web browsers, or other devices capable of rendering digital content such as games, videos, or interactive media. The display device 410 is configured to host and manage media sessions, which may include cloud-based gaming sessions, video streaming, or other interactive experiences.

FIG. 4 illustrates an exemplary system architecture for session-based device associations, highlighting the interaction between a display device 410 and multiple mobile computing devices 420(A)-420(N). In this embodiment, the display device 410—such as a smart TV, streaming device, or web browser—serves as the central hub for hosting media sessions, while the mobile computing devices 420(A)-420(N), which may include smartphones or tablets, function as controllers or input devices. The figure demonstrates how temporary associations are established between the display device and each mobile computing device, enabling seamless, secure, and context-aware interactions across single-player and multiplayer scenarios. This architecture supports dynamic management of device associations, push notifications for reconnection, and safeguards to ensure only authorized devices participate in media sessions, thereby reducing user friction and enhancing the overall user experience.

The display device 410 is equipped with an identifier, such as an Electronic Serial Number (ESN) or a globally recognized identifier (GUID), which is used to establish associations with mobile computing devices 420(A)-420(N). This identifier enables the backend system to map the display device 410 to specific media sessions and associated mobile computing devices 420(A)-420(N). The display device 410 may also include network connectivity capabilities, such as Wi-Fi or Ethernet, to communicate with backend servers and mobile computing devices 420(A)-420(N).

In some examples, an identifier of a display device can be unique to both the display device’s identity (ESN or TV) and to the user authenticated on the display device (account ID, profile ID, user ID, etc.). User authentication on the display device is optional, as some use cases (e.g. live voting) may not require the display to be user authenticated. In examples with user authentication, the systems and methods described herein can provide additional support for user privacy. As an example, a first user plays games on a common display (living room TV) with friends, and then the first user and friends leave but a second user and their friends (using their own profile in the same account or a different account) starts playing games after the first user. In this example, the system can be configured such that the first user will not receive any notifications about the second user’s activity even though the first user recently interacted with the same common display device just a few moments earlier.

In some examples, the display device 410 is responsible for generating a "beacon" when a media session is initiated. This beacon contains session-specific information, such as a session identifier or connection details, which is used to establish temporary associations with mobile computing devices 420(A)-420(N). The display device 410 may also display a QR code or other visual prompts to facilitate the initial connection with mobile computing devices 420(A)-420(N). Once a temporary association is established, the display device 410 can send push notifications to previously connected mobile computing devices 420(A)-420(N), enabling seamless reconnections without requiring repeated QR code scans.

The display device 410 supports multiple simultaneous associations with mobile computing devices 420(A)-420(N), enabling multiplayer scenarios or collaborative interactions. The display device 410 may also implement security measures, such as verifying network proximity or user intent, to ensure that only authorized mobile computing devices 420(A)-420(N) can engage with the media session.

The mobile computing devices 420(A), 420(B), 420(C), and 420(N) represent a plurality of portable electronic devices that can interact with the display device 410. These devices may include smartphones, tablets, or other mobile devices equipped with the necessary hardware and software to serve as controllers or input devices for media sessions hosted on the display device 410. Each mobile computing device 420(A)-420(N) is identified in a distinct manner by a device-specific token, such as an Apple Push Notification Service (APNS) token or a Firebase Cloud Messaging (FCM) token, which is generated by the mobile operating system and associated with the controller application installed on the mobile computing device 420(A)-420(N). Alternatively, the unique device identifier does not necessarily need to come from a mobile OS (e.g., the unique device identifier can be a proprietary identifier or mechanism).

The mobile computing devices 420(A)-420(N) are configured to establish temporary associations with the display device 410. These associations are created when a user performs an initial connection, such as scanning a QR code displayed on the display device 410. Once the association is established, the backend system stores the mapping between the display device 410 and the mobile computing devices 420(A)-420(N) for a predefined period. This temporary association enables the mobile computing devices 420(A)-420(N) to reconnect to subsequent media sessions without requiring repeated QR code scans.

Each mobile computing device 420(A)-420(N) can receive push notifications from the backend system, prompting the user to reconnect to the display device 410. These notifications may include session metadata, such as the name of the game or media content, and actionable elements, such as a "Join Now" button, which allows the user to reconnect with a single tap. The mobile computing devices 420(A)-420(N) may also display in-app prompts when the controller application is open, providing a seamless user experience.

In multiplayer scenarios, multiple mobile computing devices 420(A)-420(N) can connect to the same display device 410, enabling collaborative or competitive interactions. The system ensures that only mobile computing devices 420(A)-420(N) with valid temporary associations can participate, thereby maintaining security and preventing unauthorized access. Additionally, the mobile computing devices 420(A)-420(N) may implement client-side conditions, such as verifying network proximity or device activity, to further enhance the reliability and security of the connection process.

The mobile computing devices 420(A)-420(N) are designed to support a wide range of interaction modalities, including touch controls, voice commands, and gesture recognition, depending on the capabilities of the mobile computing devices 420(A)-420(N) and the requirements of the media session. These mobile computing devices 420(A)-420(N) contribute significantly to facilitating intuitive, responsive, and context-aware interactions with the display device 410.

As noted above, FIGS. 5-10 show components of a content distribution ecosystem in which embodiments of this disclosure are implemented according to some examples. FIG. 5 is a block diagram of a content distribution ecosystem 500 that includes a distribution infrastructure 510 in communication with a content player 520. In some embodiments, distribution infrastructure 510 may be configured to encode data and to transfer the encoded data to content player 520 via data packets. Content player 520 may be configured to receive the encoded data via distribution infrastructure 510 and to decode the data for playback to a user. The data provided by distribution infrastructure 510 may include audio, video, text, images, animations, interactive content, haptic data, virtual or augmented reality data, location data, gaming data, or any other type of data that may be provided via streaming.

Distribution infrastructure 510 generally represents any services, hardware, software, or other infrastructure components configured to deliver content to end users. For example, distribution infrastructure 510 may include content aggregation systems, media transcoding and packaging services, network components (e.g., network adapters), and/or a variety of other types of hardware and software. Distribution infrastructure 510 may be implemented as a highly complex distribution system, a single media server or device, or anything in between. In some examples, regardless of size or complexity, distribution infrastructure 510 may include at least one physical processor 512 and at least one memory device 514. One or more modules 516 may be stored or loaded into memory 514 to enable adaptive streaming, as discussed herein.

Content player 520 generally represents any type or form of device or system capable of playing audio and/or video content that has been provided over distribution infrastructure 510. Examples of content player 520 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 510, content player 520 may include a physical processor 522, memory 524, and one or more modules 526. Some or all of the adaptive streaming processes described herein may be performed or enabled by modules 526, and in some examples, modules 516 of distribution infrastructure 510 may coordinate with modules 526 of content player 520 to provide adaptive streaming of multimedia content.

In certain embodiments, one or more of modules 516 and/or 526 in FIG. 5 may represent one or more software applications or programs that, when executed by a computing device, may cause the computing device to perform one or more tasks. For example, and as will be described in greater detail below, one or more of modules 516 and 526 may represent modules stored and configured to run on one or more general-purpose computing devices. One or more of modules 516 and 526 in FIG. 5 may also represent all or portions of one or more special-purpose computers configured to perform one or more tasks.

Physical processors 512 and 522 generally represent any type or form of hardware-implemented processing unit capable of interpreting and/or executing computer-readable instructions. In one example, physical processors 512 and 522 may access and/or modify one or more of modules 516 and 526, respectively. Additionally or alternatively, physical processors 512 and 522 may execute one or more of modules 516 and 526 to facilitate adaptive streaming of multimedia content. Examples of physical processors 512 and 522 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 514 and 524 generally represent any type or form of volatile or non-volatile storage device or medium capable of storing data and/or computer-readable instructions. In one example, memory 514 and/or 524 may store, load, and/or maintain one or more of modules 516 and 526. Examples of memory 514 and/or 524 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

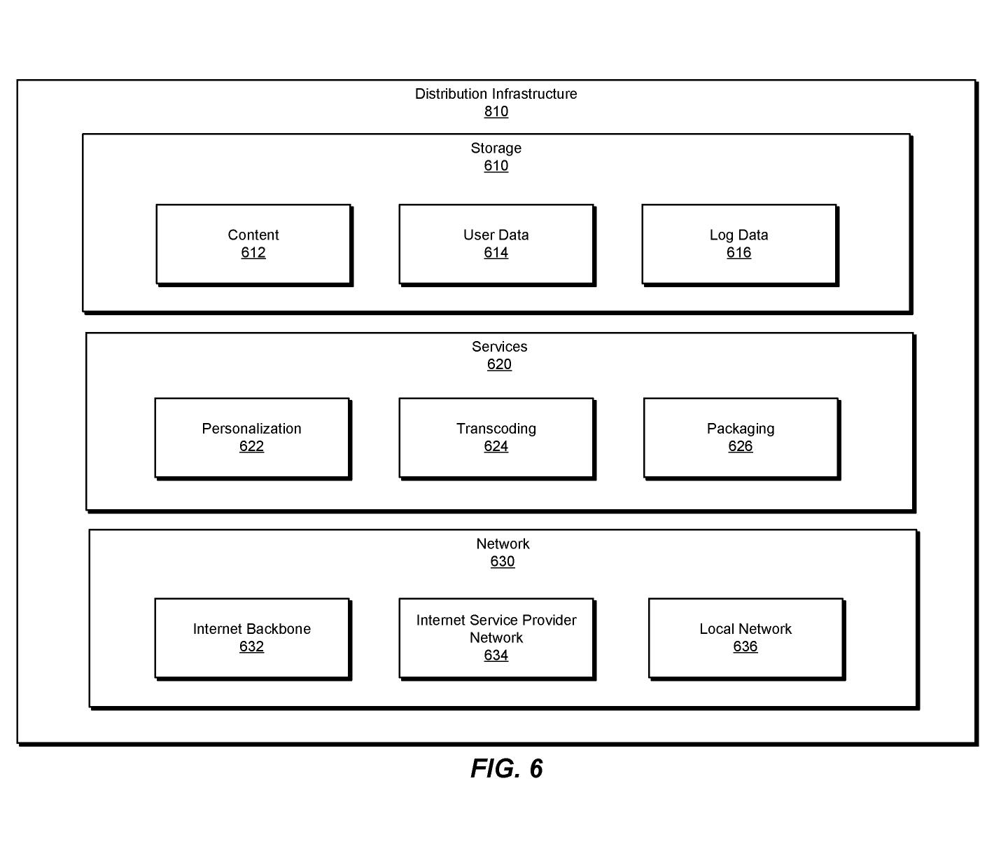

FIG. 6 is a block diagram of exemplary components of content distribution infrastructure 810 according to certain embodiments. Distribution infrastructure 810 may include storage 610, services 620, and a network 630. Storage 610 generally represents any device, set of devices, and/or systems capable of storing content for delivery to end users. Storage 610 may include a central repository with devices capable of storing terabytes or petabytes of data and/or may include distributed storage systems (e.g., appliances that mirror or cache content at Internet interconnect locations to provide faster access to the mirrored content within certain regions). Storage 610 may also be configured in any other suitable manner.

As shown, storage 610 may store, among other items, content 612, user data 614, and/or log data 616. Content 612 may include television shows, movies, video games, user-generated content, and/or any other suitable type or form of content. User data 614 may include personally identifiable information (PII), payment information, preference settings, language and accessibility settings, and/or any other information associated with a particular user or content player. Log data 616 may include viewing history information, network throughput information, and/or any other metrics associated with a user’s connection to or interactions with distribution infrastructure 810.

Services 620 may include personalization services 622, transcoding services 624, and/or packaging services 626. Personalization services 622 may personalize recommendations, content streams, and/or other aspects of a user’s experience with distribution infrastructure 810. Encoding services, such as transcoding services 624, may compress media at different bitrates which may enable real-time switching between different encodings. Packaging services 626 may package encoded video before deploying it to a delivery network, such as network 630, for streaming.

Network 630 generally represents any medium or architecture capable of facilitating communication or data transfer. Network 630 may facilitate communication or data transfer via transport protocols using wireless and/or wired connections. Examples of network 630 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 6, network 630 may include an Internet backbone 632, an internet service provider 634, and/or a local network 636.

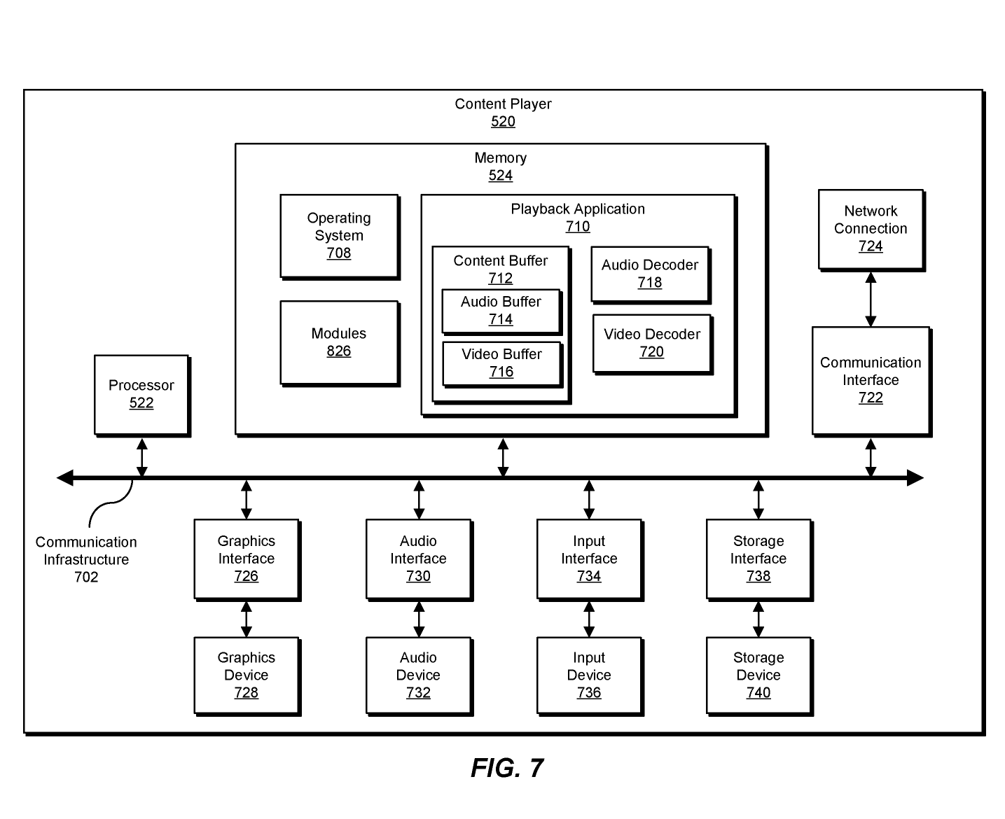

FIG. 7 is a block diagram of an exemplary implementation of content player 520 of FIG. 7. Content player 520 generally represents any type or form of computing device capable of reading computer-executable instructions. Content player 520 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 7, in addition to processor 822 and memory 824, content player 520 may include a communication infrastructure 702 and a communication interface 722 coupled to a network connection 724. Content player 520 may also include a graphics interface 726 coupled to a graphics device 728, an audio interface 730 coupled to an audio device 732, an input interface 734 coupled to an input device 736, and a storage interface 738 coupled to a storage device 740.

Communication infrastructure 702 generally represents any type or form of infrastructure capable of facilitating communication between one or more components of a computing device. Examples of communication infrastructure 702 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 824 generally represents any type or form of volatile or non-volatile storage device or medium capable of storing data and/or other computer-readable instructions. In some examples, memory 824 may store and/or load an operating system 708 for execution by processor 822. In one example, operating system 708 may include and/or represent software that manages computer hardware and software resources and/or provides common services to computer programs and/or applications on content player 520.

Operating system 708 may perform various system management functions, such as managing hardware components (e.g., graphics interface 726, audio interface 730, input interface 734, and/or storage interface 738). Operating system 708 may also process memory management models for playback application 710. The modules of playback application 710 may include, for example, a content buffer 712, an audio decoder 718, and a video decoder 720.

Playback application 710 may be configured to retrieve digital content via communication interface 722 and play the digital content through graphics interface 726. A video decoder 720 may read units of video data from audio buffer 714 and/or video buffer 716 and may output the units of video data in a sequence of video frames corresponding in duration to the fixed span of playback time. Reading a unit of video data from video buffer 716 may effectively de-queue the unit of video data from video buffer 716. The sequence of video frames may then be rendered by graphics interface 726 and transmitted to graphics device 728 to be displayed to a user.

In situations where the bandwidth of distribution infrastructure 810 is limited and/or variable, playback application 710 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 520 may also include a storage device 740 coupled to communication infrastructure 702 via a storage interface 738. Storage device 740 generally represent any type or form of storage device or medium capable of storing data and/or other computer-readable instructions. For example, storage device 740 may be a magnetic disk drive, a solid-state drive, an optical disk drive, a flash drive, or the like. Storage interface 738 generally represents any type or form of interface or device for transferring data between storage device 740 and other components of content player 520.

Many other devices or subsystems may be included in or connected to content player 520. Conversely, one or more of the components and devices illustrated in FIG. 7 need not be present to practice the embodiments described and/or illustrated herein. The devices and subsystems referenced above may also be interconnected in different ways from that shown in FIG. 7. Content player 520 may also employ any number of software, firmware, and/or hardware configurations.

Clause 1. A computer-implemented method comprising: creating a temporary association between a display device and a mobile computing device of a user that is not authenticated to the display device, the temporary association being valid for a predefined period of time; enabling, based on the temporary association, the user to use the mobile computing device to interact with a first media session on the display device; determining that the temporary association is valid for a second media session on the display device; and enabling the mobile computing device to interact with the second media session based at least in part on determining that the temporary association is still valid.

Clause 2. The computer-implemented method of clause 1, wherein the temporary association is established by receiving a device-specific token from the mobile computing device and associating the token with the display device.

Clause 3. The computer-implemented method of any of clauses 1-2, wherein enabling the mobile computing device to interact with the second media session comprises sending a push notification to the mobile computing device to prompt reconnection to the display device for the second media session.

Clause 4. The computer-implemented method of any of clauses 1-3, wherein the push notification comprises a deep link that, when activated, causes the mobile computing device to automatically connect to the display device.

Clause 5. The computer-implemented method of any of clauses 1-4, wherein the temporary association is automatically invalidated upon expiration of the predefined period of time.

Clause 6. The computer-implemented method of any of clauses 1-5, further comprising: determining, prior to allowing use of the mobile computing device to interact with the second media session, that the mobile computing device is on a same network as the display device, wherein enabling the mobile computing device to interact with the second media session based at least in part on the mobile computing device being on the same network as the display device.

Clause 7. The computer-implemented method of any of clauses 1-6, wherein the first media session and the second media session each comprise an instance of a game.

Clause 8. The computer-implemented method of any of clauses 1-7, further comprising: creating at least one additional temporary association between the display device and at least one additional mobile computing device; and enabling at least one additional user to participate in the first and second instances of the game via the at least one additional mobile computing device.

Clause 9. The computer-implemented method of any of clauses 1-8, further comprising: evaluating at least one client-side condition comprising at least one of a network fingerprint of a network of the mobile computing device, a device location of the mobile computing device, or a prior connection history of the mobile computing device, wherein: enabling the mobile computing device to interact with the second media session is based, at least in part, on the at least one client-side condition, and enabling the mobile computing device to interact with the second media session comprises displaying a connection prompt on the mobile computing device for interacting with the second media session.

Clause 10. The computer-implemented method of any of clauses 1-9, further comprising managing a lifecycle of the temporary association by generating a beacon event comprising at least one of: extending the predefined period of time that the temporary association is valid; closing the temporary association; or synchronizing a display of a notification on the mobile computing device with a state of the temporary association.

Clause 11. The computer-implemented method of any of clauses 1-10, further comprising, upon expiration of the temporary association, triggering dismissal of a connection prompt associated with the second media session.

Clause 12. The computer-implemented method of any of clauses 1-11, wherein enabling the mobile computing device to interact with the second media session is based at least in part on determining that the temporary association is still valid.

Clause 13. The computer-implemented method of any of clauses 1-12, wherein enabling the mobile computing device to interact with the second media session comprises enabling the mobile computing device to reconnect to the display device in response to a single user action in a manner that provides one-tap reconnection to the display device.

Clause 14. A system comprising: at least one physical processor; physical memory comprising computer-executable instructions that, when executed by the physical processor, cause the physical processor to: create a temporary association between a display device and a mobile computing device of a user that is not authenticated to the display device, the temporary association being valid for a predefined period of time; enable, based on the temporary association, the user to use the mobile computing device to interact with a first media session on the display device; determine that temporary association is valid for a second media session on the display device; and enable the mobile computing device to interact with the second media session based at least in part on determining that the temporary association is still valid.

Clause 15. The system of clause 14, wherein the computer-executable instructions, when executed by the physical processor, cause the physical processor to create the temporary association by receiving a device-specific token from the mobile computing device and associating the token with the display device.

Clause 16. The system of any of clauses 14-15, wherein the computer-executable instructions, when executed by the physical processor, cause the physical processor to enable the mobile computing device to interact with the second media session by sending a push notification to the mobile computing device to prompt reconnection to the display device for the second media session.

Clause 17. The system of any of clauses 14-16, the computer-executable instructions, when executed by the physical processor, further cause the physical processor to evaluate at least one client-side condition comprising at least one of a network fingerprint of a network of the mobile computing device, a device location of the mobile computing device, or a prior connection history of the mobile computing device, wherein: the computer-executable instructions, when executed by the physical processor, cause the physical processor to enable the mobile computing device to interact with the second media session based, at least in part, on the at least one client-side condition, and the computer-executable instructions, when executed by the physical processor, cause the physical processor to enable the mobile computing device to interact with the second media session by displaying a connection prompt on the mobile computing device for interacting with the second media session.

Clause 18. The system of any of clauses 14-17, wherein the computer-executable instructions, when executed by the physical processor, cause the physical processor to enable the mobile computing device to interact with the second media session by enabling the mobile computing device to reconnect to the display device in response to a single user action in a manner that provides one-tap reconnection to the display device.

Clause 19. The system of any of clauses 14-18, wherein the first media session and the second media session each comprise an instance of a game.

Clause 20. A non-transitory computer-readable medium comprising one or more computer-executable instructions that, when executed by at least one processor of a computing device, cause the computing device to: create a temporary association between a display device and a mobile computing device of a user that is not authenticated to the display device, the temporary association being valid for a predefined period of time; enable, based on the temporary association, the user to use the mobile computing device to interact with a first media session on the display device; determine that temporary association is valid for a second media session on the display device; and enable the mobile computing device to interact with the second media session based at least in part on determining that the temporary association is still valid.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform data policies automatically by auditing and correcting such policies as needed.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory computer-readable media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
creating a temporary association between a display device and a mobile computing device of a user that is not authenticated to the display device, the temporary association being valid for a predefined period of time;
enabling, based on the temporary association, the user to use the mobile computing device to interact with a first media session on the display device;
determining that the temporary association is valid for a second media session on the display device; and
enabling the mobile computing device to interact with the second media session based at least in part on determining that the temporary association is still valid.

2. The computer-implemented method of claim 1, wherein the temporary association is established by receiving a device-specific token from the mobile computing device and associating the token with the display device.

3. The computer-implemented method of claim 1, wherein enabling the mobile computing device to interact with the second media session comprises sending a push notification to the mobile computing device to prompt reconnection to the display device for the second media session.

4. The computer-implemented method of claim 3, wherein the push notification comprises a deep link that, when activated, causes the mobile computing device to automatically connect to the display device.

5. The computer-implemented method of claim 1, wherein the temporary association is automatically invalidated upon expiration of the predefined period of time.

6. The computer-implemented method of claim 1, further comprising:
determining, prior to allowing use of the mobile computing device to interact with the second media session, that the mobile computing device is on a same network as the display device,
wherein enabling the mobile computing device to interact with the second media session based at least in part on the mobile computing device being on the same network as the display device.

7. The computer-implemented method of claim 1, wherein the first media session and the second media session each comprise an instance of a game.

8. The computer-implemented method of claim 7, further comprising:
creating at least one additional temporary association between the display device and at least one additional mobile computing device; and
enabling at least one additional user to participate in the first and second instances of the game via the at least one additional mobile computing device.

9. The computer-implemented method of claim 1, further comprising:
evaluating at least one client-side condition comprising at least one of a network fingerprint of a network of the mobile computing device, a device location of the mobile computing device, or a prior connection history of the mobile computing device, wherein:
enabling the mobile computing device to interact with the second media session is based, at least in part, on the at least one client-side condition, and
enabling the mobile computing device to interact with the second media session comprises displaying a connection prompt on the mobile computing device for interacting with the second media session.

10. The computer-implemented method of claim 1, further comprising managing a lifecycle of the temporary association by generating a beacon event comprising at least one of:
extending the predefined period of time that the temporary association is valid;
closing the temporary association; or
synchronizing a display of a notification on the mobile computing device with a state of the temporary association.

11. The computer-implemented method of claim 1, further comprising, upon expiration of the temporary association, triggering dismissal of a connection prompt associated with the second media session.

12. The computer-implemented method of claim 1, wherein enabling the mobile computing device to interact with the second media session is based at least in part on determining that the temporary association is still valid.

13. The computer-implemented method of claim 1, wherein enabling the mobile computing device to interact with the second media session comprises enabling the mobile computing device to reconnect to the display device in response to a single user action in a manner that provides one-tap reconnection to the display device.

14. A system comprising:
at least one physical processor;
physical memory comprising computer-executable instructions that, when executed by the physical processor, cause the physical processor to:
create a temporary association between a display device and a mobile computing device of a user that is not authenticated to the display device, the temporary association being valid for a predefined period of time;
enable, based on the temporary association, the user to use the mobile computing device to interact with a first media session on the display device;
determine that temporary association is valid for a second media session on the display device; and
enable the mobile computing device to interact with the second media session based at least in part on determining that the temporary association is still valid.

15. The system of claim 14, wherein the computer-executable instructions, when executed by the physical processor, cause the physical processor to create the temporary association by receiving a device-specific token from the mobile computing device and associating the token with the display device.

16. The system of claim 14, wherein the computer-executable instructions, when executed by the physical processor, cause the physical processor to enable the mobile computing device to interact with the second media session by sending a push notification to the mobile computing device to prompt reconnection to the display device for the second media session.

17. The system of claim 14, the computer-executable instructions, when executed by the physical processor, further cause the physical processor to evaluate at least one client-side condition comprising at least one of a network fingerprint of a network of the mobile computing device, a device location of the mobile computing device, or a prior connection history of the mobile computing device, wherein:
the computer-executable instructions, when executed by the physical processor, cause the physical processor to enable the mobile computing device to interact with the second media session based, at least in part, on the at least one client-side condition, and
the computer-executable instructions, when executed by the physical processor, cause the physical processor to enable the mobile computing device to interact with the second media session by displaying a connection prompt on the mobile computing device for interacting with the second media session.

18. The system of claim 14, wherein the computer-executable instructions, when executed by the physical processor, cause the physical processor to enable the mobile computing device to interact with the second media session by enabling the mobile computing device to reconnect to the display device in response to a single user action in a manner that provides one-tap reconnection to the display device.

19. The system of claim 14, wherein the first media session and the second media session each comprise an instance of a game.

20. A non-transitory computer-readable medium comprising one or more computer-executable instructions that, when executed by at least one processor of a computing device, cause the computing device to:
create a temporary association between a display device and a mobile computing device of a user that is not authenticated to the display device, the temporary association being valid for a predefined period of time;
enable, based on the temporary association, the user to use the mobile computing device to interact with a first media session on the display device;
determine that temporary association is valid for a second media session on the display device; and
enable the mobile computing device to interact with the second media session based at least in part on determining that the temporary association is still valid.
